(19) United States
(12) Patent Application Publication
(10) Pub. No.: US 2002/0087554 A1
(43) Pub. Date: Jul. 4, 2002

(54) Universal medication scan code data repository (UMSCDR)

(76) Inventor: Paul Seelinger, San Diego, CA (US)

Correspondence Address: Kenneth F. Florek, Esq., HEDMAN & COSTIGAN, P.C., 1185 Avenue of the Americas, New York, NY, 10036, US

(21) Appl. No.: 10/016,868

(22) Filed: Dec. 14, 2001

Related U.S. Application Data
(60) Provisional application No. 60/255,351, filed on Dec. 15, 2000.

(51) Int. Cl. G06F 7/00

(52) U.S. Cl. 707/10

(57) ABSTRACT

A secure, Internet-based universal data repository system for medication, solution and supply product information, including recall information, that can be automatically disseminated in real time to local data repositories at healthcare institutions to enhance the institutional safe use of medications and other medical products. The data repository provides product descriptions, scan codes, equivalency information, system-specific required data, and other safety related information formatted into fields for supporting medication safe use, including support of clinical calculations.

### REFERENCE TO RELATED APPLICATIONS

This application claims the benefit of U.S. Provisional Application No. 60/255,351 filed Dec. 15, 2000.

### FIELD OF THE INVENTION

This invention is directed to a system that includes a pharmaceutical database containing product data, including data specific to the identification of products by bar code scanning or other electronic means. More particularly, the invention is directed to an Internet-based database containing specially defined and designed product identification and description data formatted into fields for the promotion of their safe and rational utilization by the healthcare industry and inpatient care settings.

### BACKGROUND OF THE INVENTION

Medication errors that occur during the delivery of patient care in the institutional setting have been an issue of national and universal concern for decades. Although hospitals and other institutions continuously strive to provide quality patient care, errors resulting in patient injury and death are occurring at significantly high and unacceptable numbers. An Institute of Medicine (IOM) Report, To Err is Human: Building a Safer Health System, called public attention to the important issue of patient safety. Further, the recent focus by the Clinton Administration on medication error prevention has added visibility to this issue. Medication errors are the most common cause of patient injuries in hospitals (see J. W. Kenagy, G. C. Stein, Naming, Labeling and Packaging of Pharmaceuticals, 2001 Amer. J. Health-Syst. Pharm. 58:2033-2041). As health care facilities continue to decrease the number of staff personnel as a cost cutting measure, the possibility of personnel errors will most likely increase.

It is important to recognize that there are many types of medication “errors” and, in accordance, various levels of severity. For example, the administration of an intravenous (IV) solution containing a chemotherapy agent (cancer drug) to the correct patient four hours late and administration of this same chemotherapy IV solution to the wrong patient both constitute an error. In the first case, the error might be considered minor, although still a type of error definition (given at the wrong time). In the second case, giving the chemotherapy IV solution to the wrong patient is much more serious, and, depending on the circumstances, could cause significant harm or even death to the patient receiving the drug. It is important, therefore, that the healthcare industry have the infrastructure needed to focus not only on reducing the number of errors but also on preventing serious errors from occurring.

Confusing drug names, labels, and packages are important sources of medication errors. The Joint Commission on Accreditation of Healthcare Organizations (JCAHO) is focusing on reducing medication errors resulting from confusing look-alike, sound-alike medications. A 2001 report by USP indicates that confusion over drug names accounted for approximately 15 percent of errors reported to USP's Medication Errors Reporting Program (MERP) from January 1996 through December 2000 (e.g. dopamine with dobutamine). Merely telling health care workers to read labels carefully is unlikely to solve the problem. In fact, product descriptions used by concurrent hospitals systems are often inconsistent, making it even more difficult for caregivers to avoid error. Improved product identification methods are is needed.

Some states have issued guidelines to help hospitals reduce medication errors, Others, such as California, have mandated near future implementation of medication error-reduction plans and error reporting systems.

The diversity of causes of errors requires many solutions. The most immediate and far-reaching may be in the area of technology implementation. One way patient safety can be improved by information technology is through the use of machine-readable codes such as bar codes in a standardized format on all medication packages and containers. The health care industry has unfortunately been slow in developing required standards and effective technology to prevent medication errors.

Over 10 years ago, automated pharmaceutical delivery systems began to be developed and marketed to reduce the high rates of medication errors associated with manual medication distribution in hospitals. During the 1990's, several companies developed and/or launched bar code scanning systems for use by caregivers to help prevent medication errors at the point of care (see Puckett F., Medication-Management Component of a Point-of-Care Information System, 1995 Amer. J. Health-Syst. Pharm 52:1305-9). These systems employ a process referred to as “bedside scanning” which requires the caregiver to scan a bar code on his/her hospital ID badge to identify who is administering the medication, the patient's wristband to identify the patient, and the product to be administered/used to insure correctness of the “Five-Rs”, i.e., Right patient for whom the medication is intended, Right medication as ordered by the prescriber for that patient, Right dose as ordered by the prescriber for that patient, Right route of administration as ordered by the prescriber for that patient and/or dictated by FDA product approval, Right time of administration as ordered by the prescriber for that patient (see Hakanson J A et al. Potential Use of Bar Codes to Implement Automated Dispensing Quality Assurance Programs, 1985 Hosp. Pharm. 20:327-37; Meyer G E et al. Use of Bar Codes in Inpatient Drug Distribution, 1991 Amer. J. Hosp. Pharm. 48:953-66).

Early adopters of this new technology have reported significant barriers to successful implementation, new potential sources of error, and major infrastructure changes that have been necessary to accommodate the technology. Currently, bedside scanning systems seem to be focused on the development of user hardware, i.e. the handheld or bedside scanning device, rather than the availability of scan code data and the imperative connectivity to other bar code enabled systems. Such systems fail to provide an underlying supporting data structure and information exchange capabilities needed to truly prevent the significant errors that cause harm to patients. Current bedside scanning products have failed to adequately address certain issues thereby limiting their effectiveness in making medication use safer.

Currently, less than 50% of manufacturers' products are bar coded for verification at the point of use, requiring that extensive repackaging and labeling of products must occur at the institutional level in order to apply needed bar codes. This manual repackaging and labeling process presents a new opportunity for human error.

Although technical standards exist for bar code formats used in health care and other industries, no standard has existed for what data the manufacturer should provide in the scan code to support safe use at the bedside.

However, in 1999, the National Coordinating Council for Medication Error Reporting and Prevention (NCC MERP), an independent body comprised of leading national organizations cooperating to address interdisciplinary causes of errors and to promote the safe use of medications, assumed the lead in attempting to assist healthcare in establishing such a data standard. In July 2001, NCC MERP, in a document entitled, “Promoting and Standardizing Bar Coding on Medication Packaging: Reducing Errors and Promoting Care,” together with the Uniform Code Council, published recommended bar code data standards for bar coding of hospital medications by manufacturers. The FDA has recently stated (December 2001) that these recommendations will soon become regulation. However, even if such a standard were regulated, the technical “platform” upon which such a standard would be universally adopted and implemented does not yet exist, and therefore, its adoption by manufacturers and the desired resultant decrease in medication errors will undoubtedly be slow to occur.

Key challenges remain in implementing an effective bedside scanning system for medication safety. For example, the process of updating and maintaining databases of product scan codes, descriptions, and other key product data at the institutional level is currently manual. This manual process must also be repeated for multiple systems in place and, therefore, is labor intensive.

Another challenge lies in the fact that, despite the existence of the communication technology such as local area network (LAN) communication, radio frequency communication, and the Internet, there is no system in place to link the manufacturer and the FDA to the patient, who is ultimately receiving the product, for the purpose of medication safe use.

Additionally, present hospital systems do not keep the caregiver informed of recall information in a timely fashion. Unfortunately, such recall information currently must also be “manually” processed (e.g. entered into the bedside scanning database and/or communicated throughout the institution) at each institution, making it subject to further delay and inaccuracy.

Currently, institutional pharmacies must repackage, label, and bar code medications to compensate for the lack of bar codes on certain manufacturers' product packages, but their approach to this repackaging and bar coding is incomplete and inconsistent throughout the healthcare industry. For example, in many cases, pharmacies are bar coding products more for the purpose of supporting their own robotic dispensing systems than they are for supporting bedside safety systems. A common result is that only those medications handled by such a robotic system receive bar codes, and bedside scanning to insure safe use of medications is not necessarily occurring.

Furthermore, scan codes within the bar codes applied by pharmacies during the repackaging process typically contain only the original product's NDC or the institution's internal product identification (billing) code. Since control or “batch” numbers assigned to products during the repackaging process are not included in the bar code, a recall of an entire “batch” found to be repackaged or labeled in error must be done by manually examining and retrieving each unit already dispensed to the patient from the patient's medication storage location in the patient care area without any assurance that all recalled doses will be retrieved.

FDA plans to require new NDC numbers in the near future. This translates to new scan codes for every unit of use package size. In effect, there will be tens of thousands of new scan codes to manage every year. There exists a need for a system that will make this management task transparent.

In addition, products mixed or compounded by the pharmacy or another caregiver for a specific patient should contain a unique identifying bar code on each container. Currently, these products are without bar codes because, if unique control or “sequence” numbers were assigned, there is no way to communicate these codes to the bedside scanning system.

Another challenge in implementing an effective bedside scanning system is the current focus on bar coding and scanning medications that have a high degree of use. Too little focus is placed on bar coding and scanning less commonly used medications that have greater potential to cause significant harm or death if administered in error. In effect, all medications must be bar coded and scanned in hospitals to achieve safe medication use, therefore all product information, including scan codes, must be readily available to bedside scanning systems.

There exists a need for one data source (database) for use by all of these admixture sources to serve as an accessible, shared repository for scan codes for product bar codes. Currently, the data management infrastructure to support this need simply does not exist. Despite the fact that technology developments allow for increased information to be imbedded within a bar code, to date there has been no realization of the potential for comprehensive, subscriber accessible product identification and safety information to enhance the quality and reliability of product labeling and administration.

In summary, medication safety in the institutional setting must be targeted at both reducing the number of potential medication errors and eliminating the types of errors that pose the most significant risk to patients. Patients should be safe from injury caused by the healthcare system. This can be achieved if the appropriate underlying data repository and data communication network is established and shared by systems that are designed to support safe use of medications. The product described in this specification will contribute to the creation of this data management infrastructure for healthcare to prevent and mitigate errors.

### SUMMARY OF THE INVENTION

Based on the above, it is an object of the present invention to provide a relational database containing one or more relational data fields, herein referred to as a Universal Medication Scan Code Data Repository (UMSCDR) for healthcare.

Another object of the present invention is to provide a data repository database with product description information that, unlike data currently available from other companies, will be formatted into the data fields required to support pharmaceutical calculations, determination of equivalencies, patient care dosing calculations, proper formatting of text for dosing instructions and directions for use.

It is a further object of the present invention to provide an Internet-based UMSCDR system that provides a continuous real time update of information for new and existing medical products based on FDA assignment and approval; real time product recalls initiated by the FDA; and real time dissemination of product and recall information to “local data repositories” in place at healthcare institutions.

Yet another object of the present invention is to provide more reliable and safe treatment of patients.

These and other objects are achieved by the present invention, directed to a secure, internet-based universal data repository system for medical product information. The system comprises a database containing the following medical product information: specially defined and designed product descriptions, safety codes, product scan codes, product equivalencies, product recall information, and optionally, company specific product information for specific technology products. The system comprises a user access data auditor, a programmed system computer means for processing and storing the medical product information, and input and output means operatively interconnected to the programmed system computer means. The input and output means include a plurality of terminals located remotely from the programmed system computer means for automatically accessing the database and displaying it to the user.

Moreover, the method of the present invention is directed to a method for creating and using product data comprising the steps of: (a) accessing product scan code information for manufactured products, (b) creating at least one product identification and description database, (c) updating product specific data in real time, and (d) disseminating product recall and FDA recall information in real time or on a designated schedule via the Internet to institutionally-based local data repositories that support and use medication safety systems at healthcare institutions.

The method of the present invention is further directed to a method for creating and using product recall information available from the FDA and manufacturers comprising the steps of: (a) accessing product scan code information for manufactured products, (b) creating at least one product recall database, (c) updating product recall data in real time, and (d) disseminating product recall information in real time or on a designated schedule via the Internet to institutionally-based local data repositories that support and use medication safety systems at healthcare institutions.

The present invention offers significant advantages to the healthcare industry and healthcare providers by providing one universal method for compiling and disseminating scan code data, specially formatted product description data, product equivalency data, system-specific product data, and recall information to support programs and automated systems designed to improve medication safety. The UMSCDR system contributes to the implementation of recently established data standards to support safe medication use, since it provides the foundation for the standard data to be used for medical product identification, control, and tracking.

The system can be used to track essentially unlimited product data. The proprietary databases may be subscriber-accessible for direct release to any persons or entities having a need or desire to disseminate product information. Exemplary users of the system may include, for example, medication technology companies that need to disseminate system specific information.

Consistent with the invention, the system of the present invention may be used to receive and store activity data from local data repositories and, in turn, bedside scanning systems, repackaging systems, and/or admixture systems for the purpose of producing a wide variety of reports related to patients and various types of items used in inventory.

The information that may be provided and generated by the database of the present invention is superior in many ways to the limited and generally static product information databases heretofore known in the art.

### BRIEF DESCRIPTION OF THE DRAWINGS

FIG. 1 is a flow chart that embodies the steps of the prior art process for supporting the bedside scanning system scan code database.

FIG. 2 is a flow chart that embodies the preferred steps of the present automated process using the UMSCDR. Generally, in conjunction with the LMSCDR, the system allows all medications and solutions to be scannable for patient safety checks.

FIG. 3 is a flow chart that embodies the steps of the prior art process for product recall notification.

FIG. 4 is a flow chart that embodies the preferred steps of the present automated product recall notification process using the UMSCDR.

FIG. 5 is a diagram showing the current medication safety architecture in hospitals comprised of systems for repackaging, admixture and bedside scanning.

FIG. 6 is a diagram showing the medication safety architecture in hospitals using the LMSCDR (IDentiSafe®).

### DETAILED DESCRIPTION OF THE PREFERRED EMBODIMENT

The preferred embodiment of the present invention provides a data repository system for controlling medical product information. The term “medical product” as used herein shall be construed to mean drugs (both prescription and over the counter), including food-supplements, herbal products and vitamins, vaccines, nonvaccine biologicals, medical devices and other medically-related goods and therapies, including plain or admixed solutions and total or peripheral parenteral nutrition. To admix is defined as the process of adding a medication to a solution and the resulting admixture is a container of admixed solution.

For the purposes of the present invention, every individual strength and/or size of a medication is a separate entity. For example, furosemide 20 mg tablets and furosemide 40 mg tablets are separate entities; furosemide 20 mg tablets in unit dose packaging and furosemide 20 mg tablets in a bulk bottle of 100 tablets are separate entities. When the product is a drug, the product is proprietary or generic. A supply product is defined as a non-medication item used in the process of administering a medication to an institutional patient; every individual strength and/or size of a supply product is a separate entity. A product is any medication or supply product as defined above.

Bar code refers to the symbol, as defined by the Health Industry Business Communication Council (HIBCC) or Uniform Code Council (UCC), affixed to a medication or supply product to identify that item to a scanning device; the bar code may also contain additional information such as production lot/batch/unique container identifier code, “use before” or expiration date, and/or safe use or warning codes. To verify other important product information at the time of use, such as a check for product recalls and product expiration, access to more information (product lot numbers and expiration dates) should be available in these scan codes.

While the use of bar codes is discussed throughout the following description, it should be understood that other identifying indicia could be used.

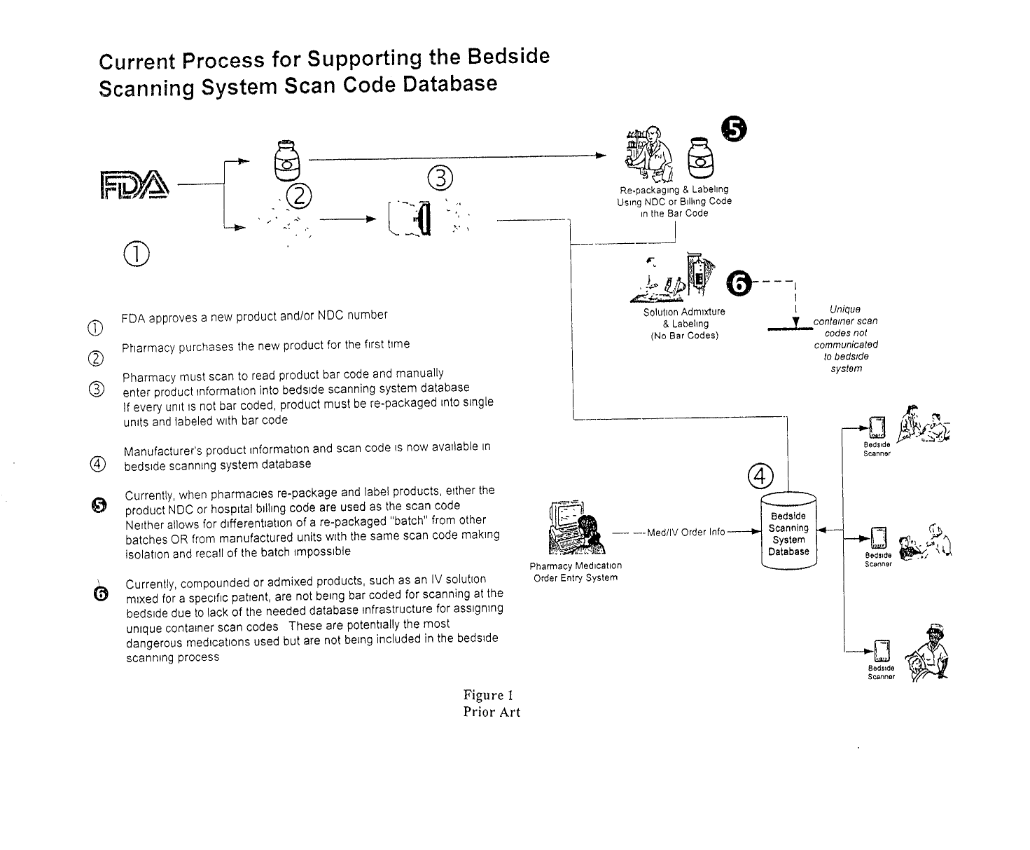

FIG. 1 shows the prior art process for supporting bedside scanning. Under this system the FDA approves a new product (1) and a pharmacy purchases the product for the first time (2). The pharmacy must scan to read the product bar code and manually enter product information into the bedside scanning system database. If every unit is not bar coded, the product must be re-packaged into single units and labeled with a bar code (3). The manufacturer's product information and scan code is now available in bedside scanning system databases (4). Under the prior art system, when pharmacies re-package and label products, either the product NDC or hospital billing code are used as the scan code. Neither allows for differentiation of a re-packaged “batch” from other batches or from manufactured units with the same scan code making isolation and recall of the batch impossible (5). Under the prior art system, compounded or admixed products, such as an IV solution mixed for a specific patient, are not bar coded for scanning at the bedside due to lack of the needed database infrastructure for assigning unique container scan codes. These are potentially the most dangerous medications used but they are not being included in the bedside scanning process (6).

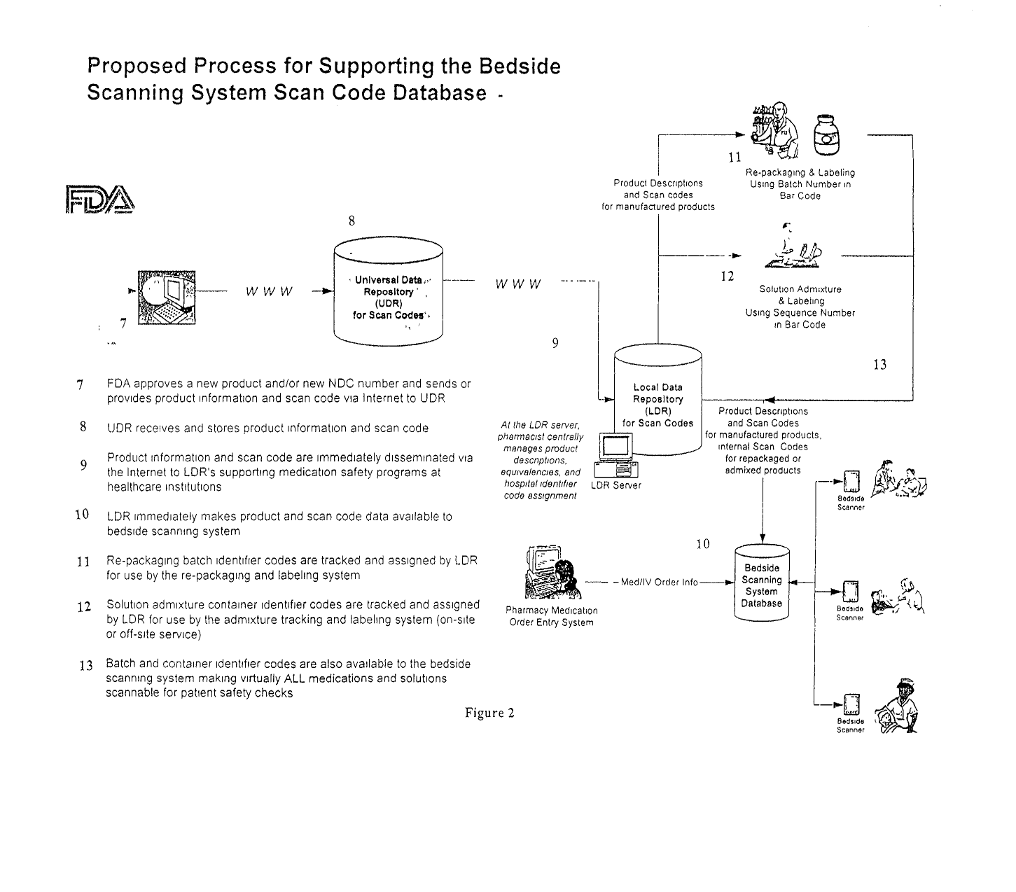

As shown in FIG. 2, the system of the present invention selectively or completely disseminates product information and FDA recall information in a timely fashion (real time or on a designated schedule) via the Internet to institutionally-based (hospital based) local data repositories (e.g., IDentiSafe®) that support and use medication safety systems at healthcare institutions. Under the present system, the FDA approves a new product and this product information and scan code are made available via the Internet to the universal data repository (UMSCDR) (7). The UMSCDR receives and stores the product information and scan code (8). If necessary, product information can be reformatted at this point to insure it supports the needs of hospitals based medication systems (8). The product information and scan code can be immediately disseminated via the Internet to local data repositories (LMSCDR's) supporting medication safety programs at healthcare institutions (9). The LMSCDR immediately makes product and scan code data available to bedside scanning systems (10). Re-packaging batch identifier codes are tracked and assigned by LMSCDR for use by the re-packaging and labeling system (11). Solution admixture container identifier codes are tracked and assigned by LMSCDR for use by the admixture tracking and labeling system (on-site or off-site service) (12). Batch and container identifier codes are also available to the bedside scanning system making virtually all medications and solutions scannable for patient safety checks (13).

The LMSCDR system has a programmed system computer for processing and storing the medical product information. The means for updating and maintaining the medical product information is a remote source database via network data communication that dynamically supplies and automatically displays or allows access to the product information. Means for both input and output of the medical product information are operatively connected to the programmed system computer. These input and output means include a plurality of terminals located remotely from the programmed system computer. Via these terminals, the medical product information is automatically accessed by, and displayed to, the user.

The UMSCDR system has two design methods for data update; direct read and/or connection via the Internet to the FDA National Drug Code (NDC) Directory or manual update by trained clinical personnel. The system administrator may grant access, such as to designated members of the FDA for dissemination of recall information and to clinical support personnel employed by IdentityHealth Technologies® for product description maintenance.

According to the preferred embodiment of the present invention, a centralized universal data repository residing on the Internet receives and stores (8) the following information on manufactured products:

(a) Product scan codes, including present and future product identification codes. As recommended by NCC MERP, the data elements in the scan code include, but are not limited to:

i) NDC, GTIN or UPC number;

ii) Lot/Control/Batch number;

iii) Expiration date;

(b) Product description information that, unlike data currently available from other companies, will be formatted into the data fields required to support pharmaceutical calculations, determination of equivalencies, patient care dosing and pharmacokinetic calculations, and proper formatting of text for dosing instructions and directions for use;

(c) Product “safety codes” (safety codes are currently non-existent but may be employed in the future);

(d) Product recall information, including data for identifying the product, lot number(s) recalled, reason(s) for recall, and severity of recall;

(e) Activity logs or audit trails to track database access by users as well as administrators and keep a history of changes.

The Scan Code includes the data contained in the ID technology that uniquely identifies the medication or supply product. As shown in FIG. 1, when pharmacists re-package and label products, either the product NDC or hospital billing code are currently used as the scan code (5). As shown in FIG. 2, which illustrates the essential steps of the proposed automated process using the UMSCDR process, the scan code may include the National Drug Code (NDC) (7), Global Trade Identification Number (GTIN), the Universal Product Code (UPC), traceable manufacturing or repackaging information (lot or batch identifier code) (11) (12), information identifying the intended patient (unique container identifier code and/or patient medication order number), “use before” or expiration information (including year, month, day, hour and minute of valid use expiration). ID technology is defined as any scanning or proximity technology, including bar code, proximity chip, Bluetooth, 802.11b, CDMA or others that is affixed to or implanted in a product or its packaging and is used to identify the product for the purpose of inventory tracking and/or safe and appropriate use.

The Batch Identifier Code is a numeric or alphanumeric code assigned to each package for a multi-package repackaging process within a hospital pharmacy. This code identifies the package as one repackaged as part of a specific repackaging event.

The NDC number is a 10 or 11 digit number that has regulatory standing with the FDA (see 21 CFR § 207.20) and is currently used by the pharmaceutical industry and healthcare organizations in automated tracking of drug products. The NDC number includes multiple components, the first component of which is generically used to identify a pharmaceutical, regardless of the manufacturer.

The UPC code is preassigned to each consumer product and for the purposes of this invention applies to botanical, supplemental and homeopathic remedies.

Another embodiment of the invention incorporates both the UPC and NDC numbers for these products.

The system includes specially defined and designed product descriptions formatted into fields and may include information regarding: recognition of medication ordered, recognition of medication dosage, recognition of medication route, recognition of medication frequency, recognition of medication duration, recognition of medication quantity, and recognition of product equivalencies. The database may also include company specific product information for specific technology products. This information assists in appropriate drug and dose selections based on individual patient information, such as age, weight and renal or hepatic function, pharmacokinetic evaluations and laboratory results.

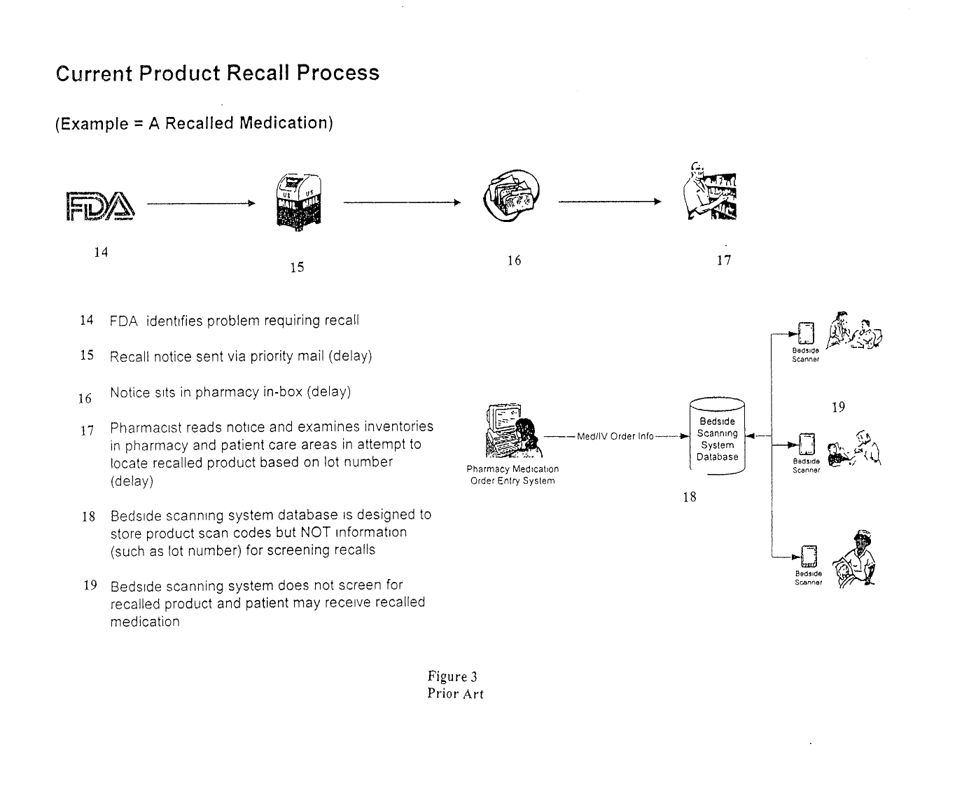

Under another aspect of the invention, FIG. 3 shows the prior art product recall process where bedside scanning systems do not screen for recalled products (19). Rather, FIG. 3 shows a process where the FDA identifies a problem requiring a recall (14). A recall notice is then sent via priority mail, email, or web site posting (delay) (15). The notice then awaits action by the pharmacy resulting in further delay (16). An additional delay occurs when the pharmacist reads the notice and examines inventories in pharmacy and patient care areas in an attempt to locate recalled product based on the lot number (17). Under the prior art recall process, the bedside scanning system database is designed to store product scan codes but not information (such as lot number) for screening recalls (18). Further, the bedside scanning system does not electronically screen for recalled product and the patient may receive recalled medication (19).

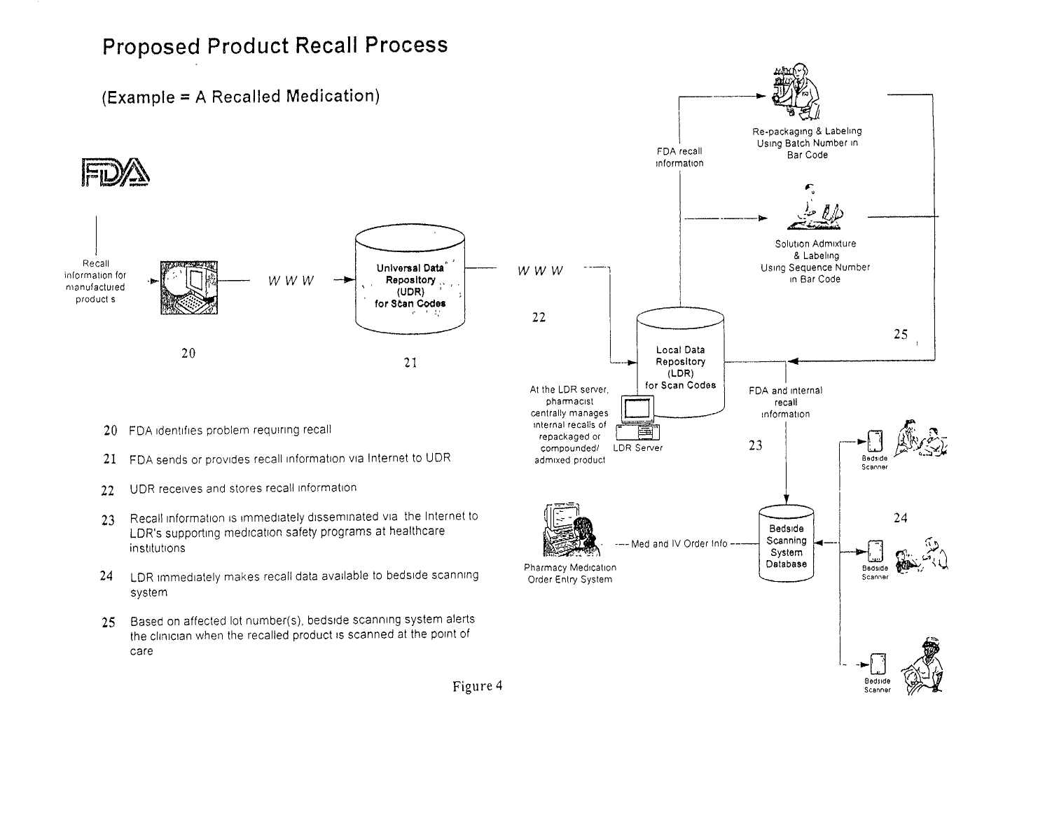

FIG. 4 shows that the system of the present invention streamlines the recall notification process and makes recall information important to the medication process easily available. Under the product recall process of the present invention, the FDA identifies a problem requiring recall (20). Here, the FDA sends or provides recall information via the Internet to the UDR (or UMSCDR) (21). The UDR receives and stores recall information (22). Recall information is immediately disseminated via the Internet to LDR's (or LMSCDR's) supporting medication safety programs at healthcare institutions (23). The LDR immediately makes recall data available to bedside scanning systems, repackaging systems and admixture systems (24). The lot number is the identifier used in the event of a recall that identifies each manufacturing batch. Via the lot number, those lots subject to recall are readily identified and are available to the bedside scanning system, repackaging systems, and admixture systems (24). Based on the affected lot number(s), these systems can alert the clinician when the recalled product is scanned at the point of use (25). Additionally, inclusion of the expiration date in the scan code ensures that the patient does not receive a medication that is beyond its expiration date.

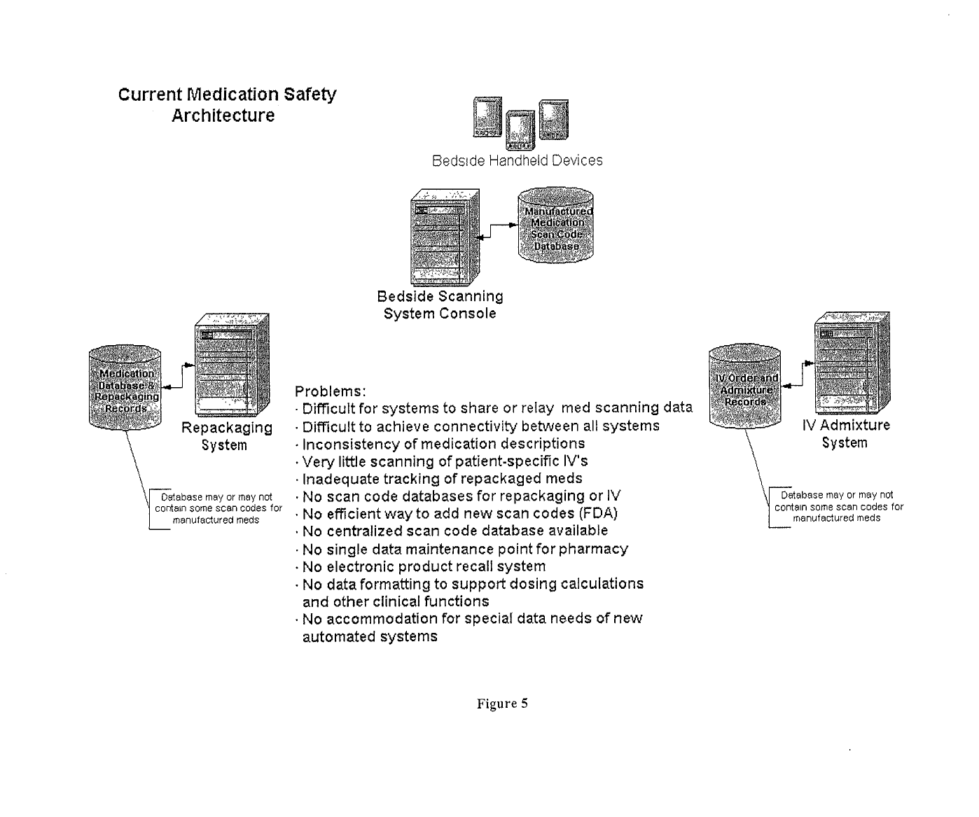

FIG. 5 shows that hospital's current medication safety architecture comprised of systems for repackaging, IV admixture and bedside scanning that are stand alone. These systems have no connectivity and do not share a common data source. There is no network for ongoing updates from external sources.

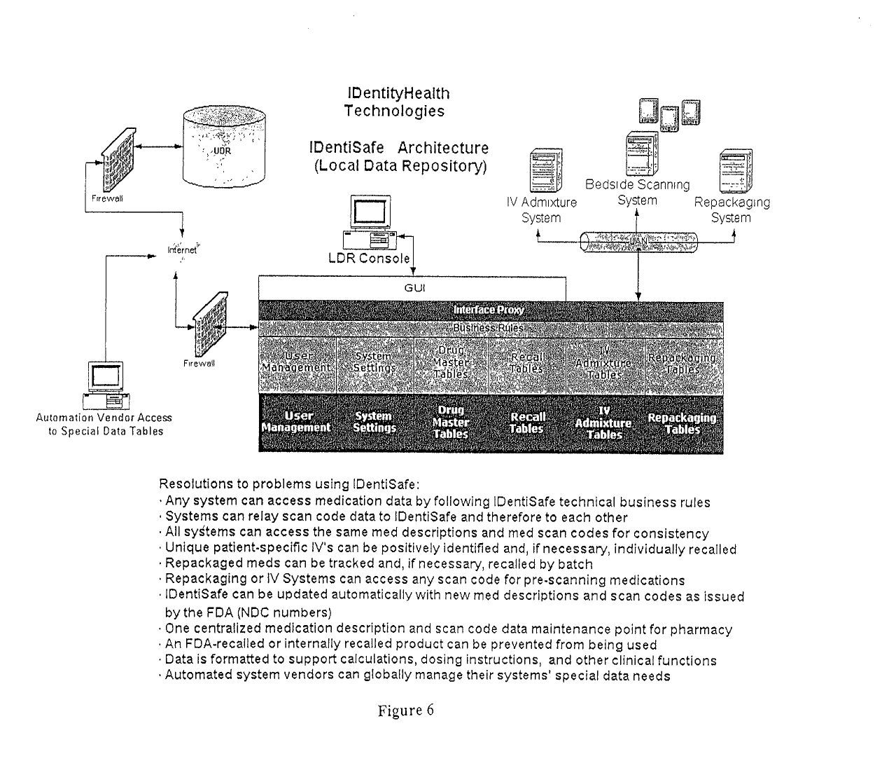

FIG. 6 shows the hospital's medication safety architecture using the LMSCDR. The repackaging, IV admixture and bedside scanning systems are all connected to a common database, the LMSCDR, for sharing access to all required data. Business rules are defined to allow these systems to interact with the LMSCDR. The LMSCDR receives updates automatically from the UMSCDR across the Internet. Security means, such as firewalls, are in place to prevent unauthorized access to the medication data. Automation vendors may have restricted access to special tables in the UMSCDR for updating and disseminating required product-specific medication data to its own installed customer systems.

Safe use or warning codes are codes assigned to the medication or supply product to trigger information and/or warnings at the point of use that contribute to insuring its safe use (e.g., a code that immediately identifies that a particular drug must not be given by direct intravenous injection or a code that a specific filter must be used with administration). In another embodiment “clinical flags”, similar to road signs warning about a dangerous intersection ahead may be displayed prominently on the computer screen. The system includes a means for automatically displaying messages to the user relating to predetermined situations.

The UMSCDR includes a user access data auditor which tracks whether or not the recall message has been viewed. The data auditor provides a user data access audit trail.

The data elements in the scan code should be uniformly ordered. Scan codes will be included on all immediate unit-of-use packaging which may include single-unit, single-dose, unit-dose, unit-of-use, multiple-unit, and multiple-dose containers.

The operating system for the present invention is preferably a windows-based system such as Microsoft Corporation's Windows NT™ or Windows 2000™ environment, a UNIX™ based system, or a LINUX™ based system running on the Internet that supports the latest releases of Internet browsers. The input means for the Windows environment is preferably mouse-driven keyed digital or scanned inputs and may optionally employ input means such as voice-activated technology, touch screen, wireless hand-held terminals. In an alternative embodiment, the system integrates input means such as wireless mobile computing and bar code data capture using a wireless Internet appliance capable of collecting data and transmitting both voice and data packets (i.e., dataphones). Such devices act a web clients, handheld computers, bar code scanners and telephones and enable users to make and receive phone calls, enter and submit data to a remote server, and scan a bar code for data capture.

Although wireless electromagnetic transmissions in the radio frequency range are the preferred embodiment, alternate types of wireless electromagnetic transmissions might be utilized, e.g., infrared.

Furthermore, in accordance with an alternative embodiment of the invention, the system may instead utilize a multi-point control unit (MCU) where video conferencing systems are interconnected.

To use the database to calculate a dosage recommendation, including an amount and a frequency of administration of a medical product, inputs may be provided from different sources and input means include any of the above.

Currently available software packages can provide the interface between the bar code reading device and the personal computer. This software can be configured to receive the input signals from the bar code reader.

In other embodiments, other types of input means and output means may be used.

In an alternative environment, the operating system is PALM. Similarly, a dual-platform design for either PALM or Windows operating system may be used.

The UMSCDR uses SQL database, Java, EJP, JSP, XML (extensible Markup Language) and/or Hypertext Markup Language (HTML) code and protocol, uses TCP/IP socket programming, and uses secure socket layer (SSL) encryption where required for security. Security features include firewall security, user logon name and password management, and redundant data storage in more than one geographic location employing a high level of physical security.

IdentityHealth Technologies®, the FDA, or a similar subscribing company that wishes to disseminate needed product specific data updates the UMSCDR in real time. Accessibility via the Internet allows “data administrators” at the FDA and/or IdentityHealth Technologies® to update product information and recall information. Controlled access to the Internet-based product data is managed by a limited number of data administrators, who are assigned the responsibility for maintaining the data repository. Such accessibility is verifiable by a system generated audit-trail. Such an archival retrospective record construction capability is a highly desirable adjunct to the security features described herein permitting full examination of record creation, such as may be required for review or legal purposes.

User access to UMSCDR data tables is strictly controlled by user type and privilege. Security is provided by password protection operating hierarchically on one or more levels, to provide varying degrees of access according to the user's level of authorization. Additional passwords may protect sensitive system-accessed information or parts thereof.

The UMSCDR product data database involves strict Internet security standards meeting or exceeding those used by the banking or similar industries. Preferred embodiments of the invention achieve this desirable result by providing a logon name and password verification supported by transparent connectivity. In an alternative embodiment, bio-pattern recognition of personal user characteristics including voice and handwriting patterns, fingerprints, and retinal scans are employed as the medium for accepting user inputs. Future developments such as more accurate and efficient bio-pattern recognition techniques may allow future embodiments of the present invention to include even more advanced biometric recognition techniques for security.

Access to the UMSCDR present invention is via a specific web address using dedicated web-based applications. A UMSCDR data administrator would use the product as follows:

1) Add product information and scan code for a new product to the universal database:

The data administrator will log on with logon name and password; indicate that a new product and corresponding scan code is to be added; enter or upload all required information describing the product into the specially designed data structure; and enter the manufacturer's corresponding product scan code. The system will then perform a check for scan code duplication and, if required, appropriate notification of such will be provided to the data administrator. The administrator will then save the data and disseminate the data to LMSCDRs at participating institutions and companies. The data administrator will have options regarding how/when “local” data repositories are updated, e.g. real time or other, such as in batch mode.

2) Initiate a product recall:

The data administrator will log on with logon name and password; indicate that a recall will be initiated; select the affected product from a list of manufactured products in the database; enter the affected lot number(s); enter the reason code(s) for recall; and enter the severity code for recall, i.e., recall level. Said data may also be automatically uploaded by the user or downloaded from the FDA recall database. The data administrator will then save the data and disseminate the data to participating institutions and companies.

Data administrators will have options regarding how/when “local” data repositories are updated (real time or other). Communication capabilities for the data will be selectively or universally sent across the Internet to similar “local” proprietary data repositories installed at health care institutions. The data will be transmitted in encrypted form to protect its content and confidential nature when applicable.

The medical product description database shown in the present invention is designed for implementation via output means consisting of a computer connected to the Internet, for example, but not limited to a personal computer, workstation, mini computer, mainframe computer, or such as physically compact, portable, user-interface devices such as small portable personal computers, especially hand-held devices known as personal digital assistants. Alternative output means include telephone interfaces incorporating modems and other equipment to accomplish digital and audio communication. Those skilled in the art will understand that the system can readily be used on or adapted to other hardware platforms.

The LMSCDR system may “seamlessly” interface with preexisting hospital pharmacy and patient information systems for access to medication profile records, admission, transfer and discharge information, and other pertinent patient specific information such as allergies, adverse drug reaction reports, and all medication record annotations, including therapeutic interventions, and other documentation. Alternatively, the LMSCDR data may be concatenated from a plurality of databases, including a pharmacy database, a medication and diagnosis database, a treatment plan database or other database, which may include lab test information, practice information, inpatient status and location or billing and appointment information. While the present disclosure provides implementation of the LMSCDR system within an Internet based system, the system may be implemented in connection with other mediums, such as, for example, but not limited to, local area network (LAN) or wide area network (WAN), or via a transmitting or receiving device such as, but not limited to, a modem.

Alternatively, in another embodiment of the invention, proprietary software may be licensed to users that will function as above. Such software may be loaded on the users computer. A user interface such as a modem may be used. It will be understood that the users computers may be linked. It will be further understood that that information can also be transferred by disk, CD ROM, ZIP™ drive, or any other computer readable storage medium, printed and then scanned in or, alternatively manually rekeyed.

Manufacturers may be charged fees for their product description, scan code information and recall information within the UMSCDR to be communicated to health care institutions in real time across the Internet.

Institutions and/or companies that provide and market bedside scanning systems, pharmacy repackaging systems, and pharmacy solution admixture systems will subscribe and be charged fees to receive real time data updates and recall information in support of their “local” medication safety systems.

Where required, companies that market systems that require unique system-specific data will be served by dedicated data tables within the UMSCDR application. The company will have the option to maintain this needed data themselves through a secure portal to a table update applet. This data will automatically be distributed to LMSCDRs.

The system formats data for submission to regulatory agencies, such as the FDA.

The present invention avoids medication errors by providing product and scan code information to local hospital databases (LMSCDR) for dissemination and access throughout the drug use process, up to the actual point of administration.

The UMSCDR system prevents patient harm by eliminating potential errors involved with manual database maintenance at the institutional level. For example, by communicating information on a recalled product directly to the bedside in real time, the system thereby prevents the product from being administered.

Thus, the universal database of the present invention achieves the above stated objectives, eliminates many of the difficulties encountered in the use of prior systems, solves problems and attains the desired results described herein.

Thus, the present invention fulfills the need for a universal system for medical product information for use by hospital or clinic environments that can more accurately correlate the use of medical items with the patient whose treatment has included their use. Specifically, it represents a new and improved information system to support evolving healthcare work processes and addresses the problem of medication errors. The present invention offers a system that solves or at least reduces the impact of the above-identified problems and other shortcomings associated with medical product information used by health care facilities.

All references cited herein, including journal articles, published or corresponding U.S. or foreign patent applications, issued U.S. or foreign patents, or any other references are entirely incorporated by reference herein.

In the foregoing description certain terms have been used for brevity, clarity and understanding. However, no unnecessary limitations are to be implied therefrom because such terms are for descriptive purposes and are intended to be broadly construed. Moreover, the descriptions and illustrations given are by way of examples and the invention is not limited to the exact details shown or described. In addition, any feature of the invention that is described in the following claims as a means for performing a function shall be construed as encompassing any means capable of performing the recited function and shall not be limited to the means disclosed in the foregoing description or any mere equivalent thereof.

Having described the features, discoveries and principles of the invention, the manner in which it is construed and utilized and the advantages and useful results obtained, the new and useful elements, arrangements, systems, equipment, operations, methods and relationships are set forth in the appended claims.

I claim:

1. A secure, internet-based universal data repository system for medical product information, said system comprising:
a) a database containing medical product information comprising one or more of the following fields or combinations of fields:
i) specially defined and formatted product descriptions, including NDC numbers;
ii) safety codes;
iii) product scan codes;
iv) product recall information; and
v) product equivalency information
vi) optionally, company specific product information for specific technology products; and
b) a user access data auditor which provides a user data access audit trail;
c) a programmed system computer for processing and storing said medical product information;
d) an input device operatively interconnected to the programmed system computer means; and
e) an output device operatively interconnected to the programmed system computer means.

2. The system of claim 1, wherein said product scan codes include at least one medication identifier and information comprising at least one of the items selected from the group consisting of: NDC number, GTIN number and UPC Code.

3. The system of claim 1, where said user access data auditor strictly controls access to Internet-based data tables by user type and privilege, and wherein said auditor logs when a user views a recall message, thereby tracking whether the recall message has been viewed.

4. The system of claim 1, comprising an updating and maintaining means for said medical product information via Internet communication by accessing a dedicated web site (URL) using web browsers.

5. The system of claim 1, wherein said input and output devices comprise a computer display screen having said medical product information displayed in fields.

6. The system of claim 1, further comprising scan codes for medications in said database.

7. The system of claim 1, further comprising a voice recognition unit for permitting said user to communicate with said system by verbal inputs.

8. The system of claim 1, wherein said input device cooperates with said voice recognition unit.

9. The system of claim 1, wherein said input means further comprises a pen interface for permitting a user to communicate with said system by writing on a screen with a pen.

10. The system of claim 1, wherein said information is received by at least one output device taken from the group consisting of voice, a keyboard, a pen and a mouse.

11. The system of claim 1, wherein said medical product is taken from the group consisting of manufactured generic, brand, over-the-counter, biologicals, blood products, medical devices, and intravenous solutions.

12. A method for creating and using product data, said method comprising the steps of:
a. accessing product scan code information for manufactured products;
b. creating at least one product identification and description database;
c. updating product specific data in real time; and
d. disseminating product information and recall information in real time or on a designated schedule via the Internet to institutionally-based local data repositories that support and use medication safety systems at healthcare institutions.

13. The method of claim 12, comprising retrieving product information across a network or the Internet from a remote source database and displaying or otherwise using retrieved product information in real time.

14. A method of creating and using product recall information, said method comprising the steps of:
a. accessing product recall information for manufactured products;
b. creating at least one product recall database;
c. updating product recall data in real time; and
e. disseminating product recall information in real time or on a designated schedule via the Internet to institutionally-based local data repositories that support and use medication safety systems at healthcare institutions.

15. The method of claim 14, wherein said at least one product recall database additionally stores previously known product recall data associated with the product.

16. The method of claim 14, further comprising means for receiving and storing messages relating to product recalls, said messages being automatically displayed to a user upon the identification of said user.

17. The method of claim 14, further comprising means for receiving and storing messages relating to product recalls, said messages consisting of data comprising at least one of the items selected from the following: identification of the product, lot numbers recalled, reason(s) for recall, and severity of recall.

18. The system of claim 1, further comprising means operable to use said medical product database and patient specific information to calculate a dosage recommendation, including an amount and a frequency of administration of said medical product.
